(19) United States
(12) Patent Application Publication
(10) Pub. No.: US 2004/0194275 A1
(43) Pub. Date: Oct. 7, 2004

(54) Method and device for the production of a metal profile

(75) Inventor: Ralf Kummle, Schopfheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Dreistern-Werk Maschinenbau GmbH & Co. KG, Schopfheim (DE)

(21) Appl. No.: 10/405,762

(22) Filed: Apr. 2, 2003

(51) Int. Cl. B23P 11/00; B21D 39/03

(52) U.S. Cl. 29/430; 228/173.7

(57) ABSTRACT

A method of producing a metal profile is provided in which a first sheet metal strip is deformed into a first profile by a plurality driven or free-running roller forming tools and, directly after the deformation process, passes through a welding station, in which a second sheet metal strip or a second profile is welded longitudinally with the first profile by means of a laser beam to form a composite profile. The second sheet metal strip, or the second profile, is hereby laid flat on the first profile, and welded on both sides along the lateral edges of the resulting contact surface. The composite profile can be produced from sheet metal strips and/or profiles with respectively different material properties. The second sheet metal strip or the second profile can be provided before welding with stampings and/or bent-up portions. A device for performing this method is also provided.

### BACKGROUND

The invention relates to a method of producing a metal profile, in which a sheet metal strip is formed into a first profile by means of a plurality of driven or free-running roller forming tools, and also a device for performing this method.

Methods and devices of this kind have long been known. According to the number of the roller forming tools, very complex profile forms can for the most part be attained from simple sheet metal strips. The number of roller shaping tools however increases with the complexity of the profile shapes, and correspondingly so does the cost in the testing phase and when equipping the shaping device.

Furthermore, the production of profiles with different wall thicknesses is known in the state of the art up to now to be very expensive. However, especially for expensive materials it is often desired to make the wall thickness thicker only where it is required for reasons of stability.

A process for the production of profiles with different or varying wall thicknesses by means of roller forming tools from a sheet metal strip is known from WO 00/29138. In this publication, it is proposed to set two or more sheet metal strips of different thickness against each other in a manner known from, e.g., DE 40 22 062 C1 on their respective long edges and to connect them together along their longitudinal edges by means of butt welding. This strip is then deformed in a conventional deforming device with roller forming tools to a profile with varying wall thicknesses. This method comes close to the earlier usual method of production of profiles with different wall thicknesses, such as extrusion methods, extrusion drawing methods, or rolling methods.

The method known from WO 00/29138 can however only be used for comparatively simply shaped profiles. Furthermore, the individual sheet metal strips have to be brought together and adjusted very accurately edge to edge, particularly in their height, and likewise accurately welded, which entails considerably expense for equipment.

### SUMMARY

The invention therefore has as its object to provide a method and a device for the production of a metal profile by means of roller forming tools, with which in particular profiles with wall thickness varying in cross section can be made at reduced cost.

This object is attained by a method and device in accordance with the present invention.

Further advantages of the method and preferred embodiments of the device for carrying out the method according to the invention are set forth in the claims.

Thus a process for producing a metal profile is provided in which a first sheet metal strip is deformed into a first profile by a plurality driven or free-running roller forming tools, after which the first profile passes, directly after the deformation process, through a welding station. In the welding station, a second sheet metal strip, or a second profile, is brought together with the first profile and laid flat on this, after which the two superimposed components are welded together to a composite profile via a laser beam on both sides along the lateral edges of the contact surface.

The method according to the invention for example makes it possible to greatly simplify the production of complex profile shapes by combining and welding together simple basic shapes. For example, doubling of the profile produced by bending the sheet metal strip around, as long known heretofore, can be replaced by welding a flat profile onto a simple support profile. The number of the roller forming tools required is thereby drastically reduced.

A profile with varying wall thickness can also be very easily produced, for example by welding on a correspondingly wide sheet metal strip onto an already finished support profile.

With the laser beam used according to the invention, the welding energy can be positioned and aligned with particular accuracy; also very accurate and reproducible regulation of the amount of energy applied with the laser to the material is possible. By the lateral application of the welding energy along the lateral edges of the contact surfaces between the first profile and the second sheet metal strip, or profile, the surface of the thereby produced second sheet metal strip or profile of the composite profile thereby produced remains substantially unaffected, especially as the laser beam is preferably directed substantially transversely of the transport direction of the first profile at the welding point and to this extent itself penetrates by boundary surface effects into the contact region between the components to be welded, and welds the components flat together. It is appropriate for this purpose if the laser beam is directed onto the welding point such that it includes an angle of 0° to about 60° with the contact surface between the first profile and the second sheet metal strip or profile. By a suitable choice of focusing and of the amount of welding energy applied, it can very easily achieved that not only the lateral outermost edges of the contact surfaces, but also at least a portion of the contact surface itself, are welded.

A particular, additional and unprecedented advantage of the method according to the invention over the heretofore known state of the art results when the composite profile of sheet metal strips and/or profiles is produced with respectively different material properties. For example, a stainless steel strip can be deformed into a first profile and can be reinforced by welding on a strip of normal steel. The use of aluminum alloys having different costs for producing the composite profiles according to the invention can have great advantages. The cost-efficient production of special profiles, in which possibly only a region of the cross section has to consist of a more costly special alloy, can be easily and rapidly carried out by the method according to the invention.

However, it should be mentioned that the words “composite profile” in connection with the invention described here are not to be narrowly interpreted. The profiles, or profile and sheet metal strip, welded together can be of identical materials throughout and can if necessary even be of identical form, without departing from the scope of the invention.

A further, enormous advantage of the method according to the invention over the state of the art heretofore is that profiles with stampings and/or bent-up portions can be produced much more easily and accurately than by the heretofore known prior art rolling techniques. Until now, either the stamped images were made in the flat sheet metal strip before deforming, the stamped images being often deformed during stamping in undesired ways, or else the finished profiles had to be provided with stampings and if necessary bent-up portions, which often led to a deformation of the profile. With the method according to the invention, all the stamping and bending operations can be performed without problems on a flat sheet metal strip, which passes through no deforming process but, after the shaping of the support profile proper, is fed to this and welded to it in the welding station.

During welding, it makes sense to position the first profile and the second sheet metal strip or the second profile by means of guide roller pairs. For a few uses, it can also be advantageous if the composite profile resulting from welding is directly fed, after the welding station, to a further deformation device with a plurality of driven or free-running roller forming tools. Thus in the first deformation device there then takes place only a shaping into the first profile, which is then connected in the welding station with a sheet metal strip or a further profile, after which the finish shaping of the composite profile takes place in the further deformation device.

A plurality of sheet metal strips and/or a plurality of profiles can of course be welded to the first profile in the welding station. Alternatively, it is also possible to provide a plurality of welding stations in the production line.

As far as two already formed profiles are to be welded into a composite profile by the process according to the invention, it offers further advantages when the roller forming tools for forming the second profile are at least partially mounted in respectively the same frames as the roller forming tools for forming the first profile. Such double frames for roller forming tools save space, are situated directly to hand and facilitate the work of adjusting the device. Furthermore, the necessary synchronization of the drives of the respective roller forming tools is facilitated.

The device according to the invention for performing the method includes a deforming device with a plurality of driven or free-running roller forming tools for deforming a first sheet metal strip to a first profile, a welding station with at least two laser welding heads in line with and following the deformation device, a feed device for common feed of a second sheet metal strip or a second profile with the first profile into the welding station, and also a positioning device for flat juxtapositioning of the first profile and the second sheet metal strip or profile in the welding station. The laser welding heads are arranged here so that they weld together the first profile and the second sheet metal strip or profile on both sides along the lateral edges of the contact surface into a composite profile.

In order to optimally bring the welding energy into the contact region of the parts to be welded together, the laser welding heads are preferably arranged so that the laser beams are directed substantially transversely of the transport direction of the first profile to the welding point. The welding energy is introduced laterally into the connection region, which has advantages particularly in regard to providing as large of a surface weld connection as possible between the two parts concerned. Insofar as the laser beam is applied to the workpieces such that it includes with the contact surface between the first profile and the second sheet metal strip or profile an angle of 0° to about 60°, the flat connection between the two involved workpieces in the region can in particular be enlarged by solely increasing the welding energy.

The sheet metal strips or profiles involved in the welding process are advantageously guided by a roller pair in the region of the laser welding heads concerned.

For welding two profiles formed form sheet metal strips, the deformation device can, as already mentioned above, be provided with a number of frames, in which roller forming tools for forming the second profile are also mounted respectively over the roller forming tools for forming the first profile.

### BRIEF DESCRIPTION OF THE DRAWINGS

An exemplary embodiment of a device according to the invention, and also examples of use of the method according to the invention, are described in detail and explained hereinafter, using the accompanying drawings.

FIG. 1 is a schematic side view of a device according to the invention;

FIG. 2 is a schematic plan view of the welding station of a device according to the invention;

FIG. 3 is a perspective view of a composite profile produced according to the invention;

FIG. 4 is a cross sectional view of the composite profile according to FIG. 3, shown during welding;

FIG. 5 is a perspective view of another composite profile produced according to the invention.

FIG. 6 is a perspective view of a further composite profile produced according to the invention.

### DETAILED DESCRIPTION OF THE PREFERRED EMBODIMENTS

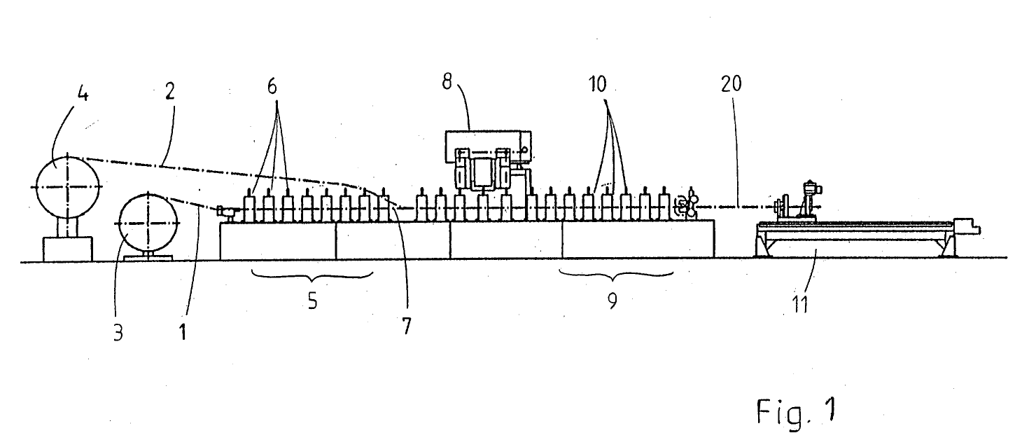

FIG. 1 shows the schematic construction of an exemplary device according to a preferred embodiment of the invention. A first sheet metal strip 1 and a second sheet metal strip 2 are unwound from a first supply coil 3 and a second supply coil 4. The first sheet metal strip 1 is conducted through a deformation device 5 with a plurality of roller forming tools 6, for shaping it into a support profile. After the deformation device 5, the shaped first profile 7 is brought together with the second sheet metal strip 2 and is supplied to a welding station 8 including a laser welding device with two welding heads. In the welding station 8, the second sheet metal strip 2 is welded onto a wall of the first profile 7 as a reinforcement, after which the resulting composite profile is finish formed in a further deformation device 9, again with a plurality of roller forming tools 10. After leaving the line formed by the first deformation device 5, the welding station 8 and the further deformation device 9, the “endlessly” produced composite profile 20 is cut to the desired length in a cutting-off machine 11.

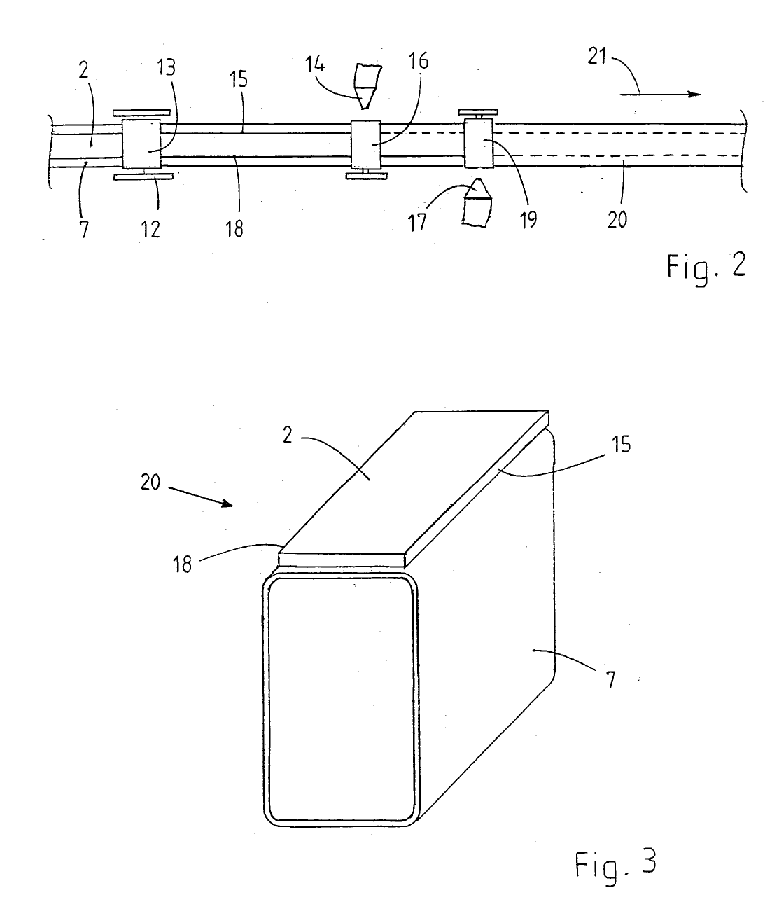

FIG. 2 shows the welding station 8 in a schematic plan view: the first profile 7, of which only the upper wall is seen, is brought together with the second sheet metal strip 2 by means of a driven guide roller pair 13 mounted in a frame 12, and in fact such that the said second sheet metal strip 2 abuts flat on the upper wall of the first profile 7. The contact surface between the first profile 7 and the second sheet metal strip 2 is thus defined by the lower surface of the second sheet metal strip 2. A first laser welding head 14 focuses a laser beam from the left side onto the left lateral boundary 15 of the contact surface, while a first roller pair 16 presses the second sheet metal strip 2 onto the first profile 7. A second laser welding head 17 correspondingly focuses a laser beam onto the right-hand edge 18 of the contact surface while a second roller pair 19 again presses the second sheet metal strip 2 onto the first profile 7. An uninterrupted weld seam is thus ensured, even when there are possible internal stresses of the first profile 7 and the second sheet metal strip 2. The composite profile 20 arising in the welding station leaves the welding station in the transport direction 21.

FIG. 3 shows a portion of the composite profile 20 produced in FIGS. 1 and 2 and composed of the first profile 7 and the second sheet metal strip 2 welded onto this. The finished composite profile 20 thus has a reduced wall thickness in zones of low loading and an increased wall thickness in the zone of higher loading. A clear saving of material is achieved here as compared to conventionally produced profiles having an equal load bearing capability. It should furthermore be mentioned at this point that different materials can also be used throughout the composite profile 20 shown. For example, the first profile 7 can be formed of stainless steel, which is reinforced with a sheet metal strip 2 formed of inexpensive low carbon steel at the place where a higher stability of the composite profile 20 is necessary.

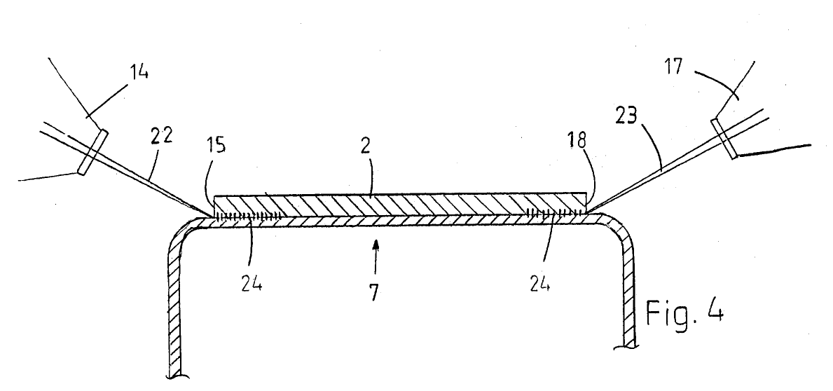

FIG. 4 shows in cross section the upper half of the composite metal sheet 20 of FIG. 3, during the welding process. For clarity, the laser welding heads 14 and 17 are furthermore shown. The left-hand edge 15 and the right-hand edge 18 of the second sheet metal strip 2 border on the contact surface between the first profile 7 and the second sheet metal strip 2. The laser beams 22 and 23, which are emitted by the laser welding heads 14 and 17, are aligned exactly on the contact regions on the left-hand edge 15 and on the right-hand edge 18 of the contact surface and also are adjusted in their energy beam and beam angle such that the two components are welded together in the flat regions 24 respectively extending from the left-hand edge 15 or the right-hand edge 18.

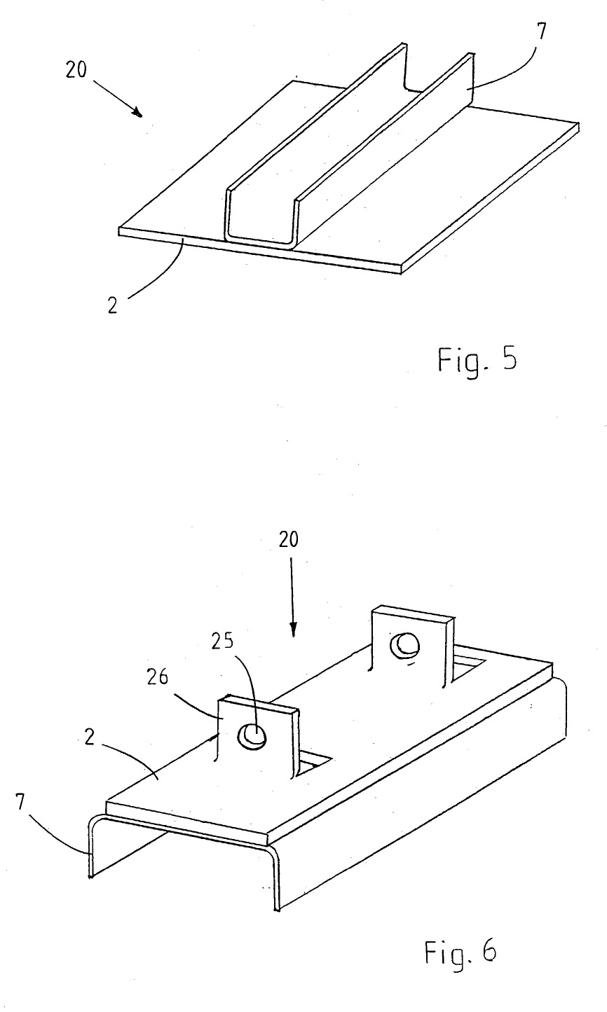

FIG. 5 shows another exemplary use for the method according to the invention. Here a wide, second sheet metal strip 2 is welded onto the first profile 7, resulting in a composite profile 20 whose shape would have required two doublings, to be produced by completely bending around, with the conventional technique. The two partial profiles welded together in the composite profile 20 however are formed solely of simple basic shapes which are correspondingly simple to form. The composite profile 20 shown here can if necessary be still further processed in the further deformation device 9.

Finally, FIG. 6 shows a third use example for the method according to the invention. Here the first profile 7 is welded to the second sheet metal strip 2, which had been provided beforehand with a number of stampings 25 and bent-up portions 26. The result is a precision component constructed as a composite profile 20 without deformation of the stamped images or of the profile form. As will be seen here, the functional elements produced by stampings 25 and bent-up portions 26 can be dimensioned without consideration of the final required profile thickness, which offers a further considerable advantage over the prior known state of the art. Here it should also be mentioned that the first profile 7 and the second sheet metal strip 2 do not have to be formed of the same material.

In conclusion, it is again to be established that the invention is not limited to the embodiment examples shown, but in particular also includes bringing together and connecting together more than two sheet metal strips or profiles, and also the most varied combinations of dimensions and materials for the sheet metal strips.

List of Reference Numerals

| | |
|---|---|
| 1 | sheet metal strip (first) |
| 2 | sheet metal strip (second) |
| 3 | supply coil (first) |
| 4 | supply coil (second) |
| 5 | deformation device |
| 6 | roller forming tools |
| 7 | profile (first) |
| 8 | welding station |
| 9 | deformation device (further) |
| 10 | roller forming tools (further) |
| 11 | cutting-off machine |
| 12 | frame |
| 13 | guide roller pair |
| 14 | laser welding head (first) |
| 15 | left-hand edge |
| 16 | roller pair (first) |
| 17 | laser welding head (second) |
| 18 | right-hand edge |
| 19 | roller pair (second) |
| 20 | composite profile |
| 21 | transport direction |
| 22 | laser beam (first) |
| 23 | laser beam (second) |
| 24 | contact regions |
| 25 | stamping |
| 26 | bent-up portion |

1. A method of producing a metal profile, comprising:
forming a first sheet metal strip into a first profile using a plurality of driven or free-running roller forming tools;
directly following the forming process, passing the first profile through a welding station;
guiding a second sheet metal strip or profile together with the first profile into the welding station and laying it flat on the first profile;
longitudinally welding the first profile and the second sheet metal strip or profile that is laid flat on the first profile on both sides along lateral edges of a contact surface using a laser beam, to form a composite profile.

2. The method according to claim 1, further comprising:
directing the laser beam onto the welding point substantially transversely to a transport direction of the first profile.

3. The method according to claim 2, wherein
the laser radiation is directed onto the welding point such that it includes an angle of 0° to about 60° with the contact surface between the first profile and the second sheet metal strip or profile.

4. The method according to claim 1, further comprising:
producing the composite profile from sheet metal strips and/or profiles with respectively different material properties.

5. The method according to claim 1, further comprising:
stamping and/or bending-up portions of the second sheet metal strip or profile before welding.

6. The method according to claim 1, wherein
the second sheet metal strip or profile is a second profile, and the first profile and the second profile are welded together to form a composite profile, the method further comprising forming the second profile beforehand using a second plurality of roller forming tools which are mounted at least partially in frames that are the same frames used to support the roller forming tools for shaping the first profile.

7. The method according to claim 1, further comprising:
passing the composite profile through a further deformation device with a plurality of driven or free-running roller forming tools after welding.

8. The method according to claim 1, further comprising
welding a plurality of sheet metal strips and/or a plurality of profiles to the first profile in the welding station.

9. A device for welding a first profile and a second sheet metal strip or profile that is laid flat on the first profile on both sides along lateral edges of a contact surface therebetween using a laser beam, to form a composite profile, comprising:
a deformation device (5) having a plurality of driven or free-funning roller forming tools (6) for deformation of a first sheet metal strip (1) to a first profile (7);
a welding station (8) with at least two laser welding heads (14, 17), arranged in line with, and following, the deformation device (5);
a feed device (12, 13) for feeding a second sheet metal strip (2) or a second profile in common with the first profile (7) into the welding station (8);
a positioning device (13, 16, 19) for superimposing the first profile (7) and the second sheet metal strip (2) or profile, flat in the welding station (8); and
the laser welding heads (14, 17) being arranged such that they weld on both sides along lateral edges (15, 18) of a contact surface between the first profile (7) and the second sheet metal strip (2) or profile to form a composite profile (20).

10. The device according to claim 9, wherein
the laser welding heads (14, 17) are arranged such that the laser beams (22, 23) are directed onto the lateral edges (15, 18), substantially transversely to a transport direction (21) of the first profile (7).

11. The device according to claim 10, wherein
the laser beams (22, 23) form an angle of 0° to about 60° with the contact surface between the first profile (7) and the second sheet metal strip (2) or profile.

12. The device according to claim 9, wherein
the laser welding heads are adapted to weld the sheet metal strips (1, 2) and/or the profile (7) respectively that have different material properties.

13. The device according to claim 9, wherein
the second sheet metal strip (2) or the second profile has stampings (25) and/or bent-up portions (26).

14. The device according to claim 9, wherein
the deformation device (5) includes a number of frames, which respectively also have roller forming tools for shaping the second profile in addition to the roller forming tools for shaping the first profile (7).

15. The device according to claim 9, further comprising:
a furhter deformation device (9) having a plurality of driven or free-running roller forming tools (10) arranged in line after the welding station (8).

16. The device according to claim 9, wherein
the device is adapted to weld a plurality of sheet metal strips and/or plural profiles together with the first profile (7) in the welding station (8).
